(19) United States
(12) Patent Application Publication
(10) Pub. No.: US 2013/0089343 A1
(43) Pub. Date: Apr. 11, 2013

(54) IMAGE FORMING APPARATUS AND METHOD THEREOF

(71) Applicant: Michiaki NISHIMURA, Osaka (JP)

(72) Inventor: Michiaki NISHIMURA, Osaka (JP)

(21) Appl. No.: 13/599,445

(22) Filed: Aug. 30, 2012

(30) Foreign Application Priority Data
Oct. 5, 2011 (JP) 2011-220806

(51) Int. Cl. G03G 15/00

(52) U.S. Cl. 399/12

(57) ABSTRACT

An image forming apparatus is provided with an image forming portion for forming an image, a nongenuine product judging portion for judging whether or not a toner cartridge as a replacement part of the image forming portion is a nongenuine product and a control portion for controlling the image forming portion according to an image forming condition input from a copy condition input screen or a print condition input screen. In a case where the toner cartridge of the image forming portion is judged as a nongenuine product by the nongenuine product judging portion, the control portion restricts input of a condition concerning recording paper among the image forming conditions capable of being input from the copy condition input screen or the print condition input screen.

### CROSS-NOTING PARAGRAPH

This non-provisional application claims priority under 35 U.S.C. §119(a) on Patent Application No. 2011-220806 filed in JAPAN on Oct. 5, 2011, the entire contents of which are hereby incorporated herein by reference.

### FIELD OF THE INVENTION

The present invention relates to an image forming apparatus and a method thereof, and more particularly to an image forming apparatus provided with a function that judges whether or not a replacement part is a nongenuine product, and a method thereof.

### BACKGROUND OF THE INVENTION

For replacement parts of a photoreceptor drum, a transfer belt, a toner cartridge and the like which are used for an image forming apparatus such as a multi-functional peripheral, a distributor of a device provides genuine supplies thereof for assuring print quality, while a third party other than the distributor has been increasingly selling supplies as interchangeable parts. The interchangeable parts are inexpensively supplied, whose print quality is however not assured at all, and a seller of the interchangeable parts has not been responsible for maintenance of equipment under the circumstances. Further, since such a multi-functional peripheral is not designed to support even nongenuine supplies, in the case of using a nongenuine product, blur, fog and the like of printing are notably caused under environmental conditions such as high temperature, high humidity, low temperature, low humidity and the like, posing a problem of reduction in print quality.

Whereas, for example, Japanese Laid-Open Patent Publication No. 2010-266588 describes an image forming apparatus recognizable whether or not a replacement part is a genuine product. In such an image forming apparatus, manufacturer name information of a toner is read from a memory tag incorporated in a toner cartridge to compare the read company name information to company name information stored in advance, and determination is made, in the case of match, that a mounted toner cartridge is a genuine product to display the company name information on a display portion, followed by execution of image density correction action, while determination is made, in the case of mismatch, that the mounted toner cartridge is a nongenuine product not to display the company name information on the display portion, as well as displaying that the image density correction action is not executed.

Additionally, Japanese Laid-Open Patent Publication No. 2009-300694 describes an image forming apparatus capable of selecting a first mode assuming use of genuine consumables and a second mode permitting use of nongenuine consumables. Such an image forming apparatus is comprised of consumables judgment means for judging whether mounted consumables are genuine or nongenuine, and print job receiving means for receiving a print instruction, in which, when the first mode is selected, in a case where consumables to be used in order to reproduce a color instructed for printing in the print job receiving means includes consumables judged as nongenuine by the consumables judgment means, the consumables judged as nongenuine is not used, and only the consumables judged as genuine is used to form an image.

Here, recording paper to be used for a multi-functional peripheral includes plain paper, a letterhead, printed paper, recycled paper, colored paper, label paper, a tab, cardboard, thin paper, OHP paper and the like, in which for transfer, fixation of a toner and the like to special paper represented by a tab, a cardboard, thin paper and OHP paper, even a manufacturer of the multi-functional peripheral suffers from deriving a combination of bias and temperature setting for securing favorable print quality conforming to genuine parts under the circumstances.

In the case of using such special paper, when a nongenuine product is used for a photoreceptor drum, a transfer belt, a toner cartridge or the like under an image forming condition established for a genuine product, a defect is easily caused in formation, primary transfer, secondary transfer, fixation and the like of an electrostatic latent image with charging bias set by a manufacturer, so that it becomes extremely difficult to perform favorable image formation. Therefore, a problem is posed such that unevenness, fog and the like of an image are caused, which leads to wasteful consumption of recording paper and electricity.

Additionally, along with miniaturization of an apparatus recently, a thin photoreceptor drum (for example, φ30 mm) is used, and even with plain paper, it is thus configured to form one image on A4 paper in landscape orientation by three rotations of the photoreceptor drum. Then, there is also a problem that recording paper having long length in a conveyance direction of the recording paper (for example, B4 paper or larger) is used in a state where a nongenuine product is mounted on an apparatus, whereby unevenness of an image stands out due to uneven charging of the photoreceptor drum that is synchronized with a rotation period of the photoreceptor drum so as to degrade print quality of printed matter.

Whereas, with techniques described in the above-described Japanese Laid-Open Patent Publication No. 2010-266588 and Japanese Laid-Open Patent Publication No. 2009-300694, it is impossible to perform favorable printing in the case of detecting that a toner cartridge is a nongenuine product, thus prohibiting image density correction, or performing printing only with a genuine product without using a nongenuine product in a case where high image quality is required, however, the above-described problems have been never considered. Further, in a case where a nongenuine product is used, there is also a method of prohibiting printing operation, however, a uniform ban results in significantly impaired user's convenience.

### SUMMARY OF THE INVENTION

The present invention is devised in light of the above-described problems, and an object of the present invention is to provide an image forming apparatus capable of suppressing waste of recording paper due to unevenness, fog and the like in an image without impairing user's convenience even in the case of using a nongenuine product for a replacement part, and a method thereof.

An object of the present invention is to provide an image forming apparatus comprising, an image forming portion for forming an image, a nongenuine product judging portion for judging whether or not a replacement part of the image forming portion is a nongenuine product; and a control portion for controlling the image forming portion according to an image forming condition input from an image forming condition input portion, wherein in a case where the replacement part of the image forming portion is judged as a nongenuine product by the nongenuine product judging portion, the control portion restricts input of a condition concerning recording paper among image forming conditions that can be input from the image forming condition input portion.

Another object of the present invention is to provide the image forming apparatus, wherein the condition concerning the recording paper is a kind of the recording paper, and the control portion restricts so as not to be able to input special paper among kinds of the recording paper that can be input from the image forming condition input portion.

Another object of the present invention is to provide the image forming apparatus, wherein the condition concerning the recording paper is a kind of the recording paper, and the control portion restricts so as not to be able to input special paper among kinds of the recording paper that can be input from the image forming condition input portion when a size of the recording paper of a predetermined size or more is input from the image forming condition input portion.

Another object of the present invention is to provide the image forming apparatus, wherein the condition concerning the recording paper is a size of the recording paper, and the control portion restricts so as not to be able to input the paper of a predetermined size or more among sizes of the recording paper capable of being input from the image forming condition input portion.

Another object of the present invention is to provide the image forming apparatus, wherein the control portion informs, in the case of restricting the condition concerning the recording paper, that the replacement part of the image forming portion is restricted because of being a nongenuine product.

Another object of the present invention is to provide the image forming apparatus, wherein a detection portion for detecting temperature and/or humidity is included, and when the replacement part of the image forming portion is judged as a nongenuine product and the temperature and/or the humidity detected by the detection portion do not fall within a predetermined range, the control portion prohibits all input of the image forming conditions that can be input from the image forming condition input portion so as not to allow execution of image forming processing.

Another object of the present invention is to provide the image forming apparatus, wherein the image forming apparatus is connected via a network to an information processing apparatus in which a printer driver is installed, and the image forming condition input portion includes a print condition input screen of the printer driver that is displayed on a display portion of the information processing apparatus.

Another object of the present invention is to provide an image forming method by means of an image forming apparatus provided with an image forming portion for forming an image; a nongenuine product judging portion for judging whether or not a replacement part of the image forming portion is a nongenuine product; and a control portion for controlling the image forming portion according to an image forming condition input from an image forming condition input portion, comprising: a judging step that the nongenuine product judging portion judges whether or not the replacement part of the image forming portion is a nongenuine product; an input restriction step that the control portion input of a condition restricts concerning recording paper among image forming conditions that can be input from the image forming condition input portion in a case where the placement part is judged as a nongenuine product at the judging step; and an image forming step that the image forming portion performs image formation based on an image forming condition in which the condition concerning the recording paper is restricted at the input restriction step.

### BRIEF DESCRIPTION OF THE DRAWINGS

FIG. 1 is a diagram showing an embodiment in which an image forming apparatus according to the present invention is configured as a multi-functional peripheral;

FIG. 2 is a block diagram showing an exemplary main configuration of the image forming apparatus according to the present invention and an information processing apparatus;

FIG. 3 is a diagram showing an example of a toner cartridge as a replacement part;

FIG. 4 is a flow diagram explaining an example of an image forming method by means of the image forming apparatus of the present invention;

FIG. 5 is a diagram showing an example of appearance of an operation panel included in the image forming apparatus;

FIG. 6 is a diagram showing an example of an initial screen in a copy mode;

FIG. 7 is a diagram showing an example of a copy condition input screen for selecting a paper type (kind of paper) in a case where the toner cartridge is a genuine product;

FIG. 8 is a diagram showing an example of the copy condition input screen for selecting a paper size in a case where the toner cartridge is a genuine product;

FIG. 9 is a diagram showing an example of the copy condition input screen for selecting a paper type in a case where the toner cartridge is a nongenuine product;

FIG. 10 is a diagram showing an example of the copy condition input screen for selecting a paper size in a case where the toner cartridge is a nongenuine product;

FIG. 11 is a diagram showing a screen example for inputting a condition of paper to be set to a paper feeding cassette;

FIG. 12 is a diagram showing a screen example for inputting a condition of paper to be set to a paper feeding cassette;

FIG. 13 is a diagram showing an example of the print condition input screen with a printer driver for selecting a paper size in a case where the toner cartridge is a genuine product;

FIG. 14 is a diagram showing an example of the print condition input screen with the printer driver for selecting a paper type in a case where the toner cartridge is a genuine product;

FIG. 15 is a diagram showing an example of the print condition input screen with the printer driver for selecting a paper size in a case where the toner cartridge is a nongenuine product; and

FIG. 16 is a diagram showing an example of the print condition input screen with the printer driver for selecting a paper type in a case where the toner cartridge is a nongenuine product.

### PREFERRED EMBODIMENTS OF THE INVENTION

Hereinafter, description will be given for preferred embodiments of an image forming apparatus and a method thereof of the present invention with reference to accompanying drawings.

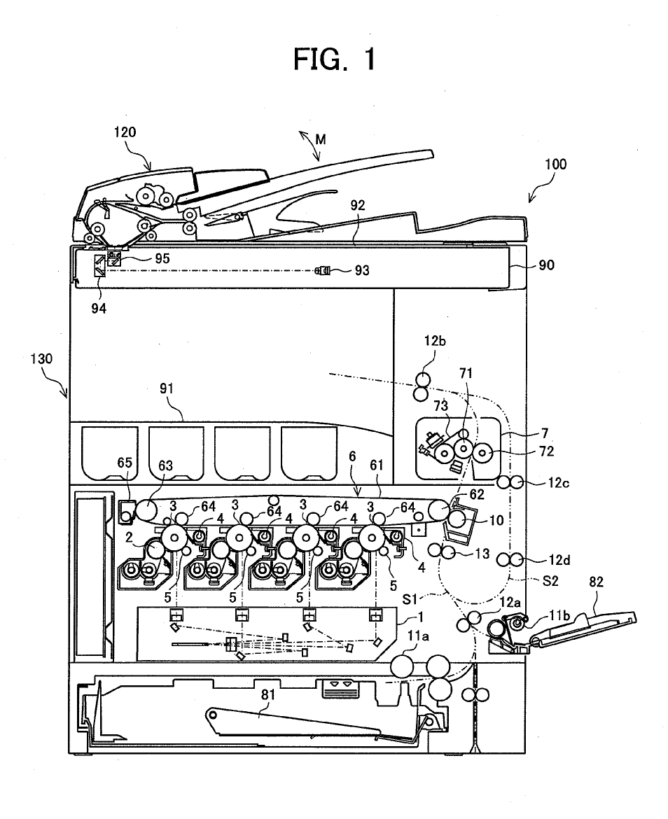

FIG. 1 is a diagram showing an embodiment in which the image forming apparatus according to the present invention is configured as a multi-functional peripheral, showing an example of the image forming apparatus configured as a multi-functional peripheral provided with a scanner function.

An image forming apparatus 100 forms an image on recording paper from image data which is transmitted from the outside, or read by a scanner (image reading means), and is comprised of an apparatus 130 and an automatic document processing device 120.

The apparatus 130 includes an exposure unit 1, a developing equipment 2, a photoreceptor drum 3, a cleaner unit 4, a charger 5, an intermediate transfer belt unit 6, a fixing unit 7, a paper feeding cassette 81, a paper discharge tray 91 an the like.

In an upper part of the apparatus 130, a document platen 92 made of transparent glass is provided, and on an upper side thereof, the automatic document processing device 120 is installed for automatically feeding a document onto the document platen 92. The automatic document processing device 120 is configured so as to rotate freely in an arrow M direction, and the top of the document platen 92 is opened so that it is possible to place a document by hand.

The apparatus 130 includes image reading means 90 that is contained in a housing. The image reading means 90 is reduced optical system image reading means which is comprised of a light source unit 93 holding a light source and a first mirror, a mirror unit 94 holding a second mirror and a third mirror, a lens and a CCD 95. Further, the apparatus 130 is provided with a not illustrated operation panel so as to enable operation input by a user. Moreover, the apparatus 130 is provided with means for inputting image data from a device connected to the outside, or means for reading image data from a transportable recording medium (both of them are not illustrated).

Image data which is processed in the image forming apparatus 100 corresponds to a color image in four colors of black (K), cyan (C), magenta (M) and yellow (Y), for example. Accordingly, four pieces for each of the developing equipment 2, the photoreceptor drum (image carrier) 3, the charger 5 and the cleaner unit 4 are provided so as to form four types of latent images corresponding to each color, whereby four image stations are constituted.

The charger 5 is a charging means for uniformly charging the surface of the photoreceptor drum 3 to predetermined potential, and for which, contact-type roller type and brush type chargers are used in addition to a charger type as shown in FIG. 1 in some cases.

The exposure unit 1 is configured as a laser scanning unit (LSU) provided with a laser emission portion, a reflective mirror and the like. In the exposure unit 1, a polygon mirror that scans by a laser beam, and optical elements such as a lens, a mirror and the like for guiding a laser beam that is reflected by the polygon mirror to the photoreceptor drum 3 are arranged. In addition, for the exposure unit 1, it is also possible to employ a method of using, for example, EL and LED writing heads in which light-emitting devices are disposed in an array.

The exposure unit 1 includes a function for exposing the charged photoreceptor drum 3 according to input image data, thereby, on which surface, forming an electrostatic latent image according to the image data. The developing equipment 2 forms the electrostatic latent image that is formed on each of the photoreceptor drums 3 with toners in four colors (Y, M, C and K). Further, the cleaner unit 4 removes/collects a toner which remains on the surface of the photoreceptor drum 3 after development and image transfer.

The intermediate transfer belt unit 6 that is arranged on an upper side of the photoreceptor drum 3 is provided with an intermediate transfer belt 61, an intermediate transfer belt driving roller 62, an intermediate transfer belt driven roller 63, an intermediate transfer roller 64 and an intermediate transfer belt cleaning unit 65. Four intermediate transfer rollers 64 are provided corresponding to each color of Y, M, C and K.

The intermediate transfer belt 61 is stretched out among and rotationally driven by the intermediate transfer belt driving roller 62, the intermediate transfer belt driven roller 63 and the intermediate transfer roller 64. Further, each intermediate transfer roller 64 imparts transfer bias for transferring a toner image of the photoreceptor drum 3 onto the intermediate transfer belt 61.

The intermediate transfer belt 61 is provided in contact with each photoreceptor drum 3. Then, toner images in respective colors that are formed on the photoreceptor drum 3 are sequentially superimposed on and transferred onto the intermediate transfer belt 61, thereby forming a color toner image (multicolor toner image) on the intermediate transfer belt 61. The intermediate transfer belt 61 is formed in an endless shape with use of, for example, a film with thickness of about 100 μm to 150 μm.

The toner image is transferred from the photoreceptor drum 3 to the intermediate transfer belt 61 by the intermediate transfer roller 64 in contact with a back side of the intermediate transfer belt 61. To the intermediate transfer roller 64, high-voltage transfer bias (high voltage with polarity (+) opposite to charging polarity (−) of a toner) is applied in order to transfer the toner image. The intermediate transfer roller 64 is a roller based on a metal (for example, stainless-steel) axis with a diameter of 8 to 10 mm, whose surface is covered by a conductive elastic material (for example, EPDM, urethane form or the like). Such a conductive elastic material allows high voltage to be uniformly applied to the intermediate transfer belt 61. In this structural example, a roller shape is used as transfer electrode, however, a brush type or the like is also usable otherwise.

An electrostatic image which is formed on each photoreceptor drum 3 corresponding to each color phase as described above is layered on the intermediate transfer belt 61. The electrostatic image layered in this manner is transferred onto recording paper by the transfer roller 10 as a secondary transcriptional mechanical portion described below that is arranged in a contact position of a sheet and the intermediate transfer belt 61 by rotation of the intermediate transfer belt 61. As the secondary transcriptional mechanical portion, not only a transfer roller but also a corona charger as well as a transfer belt are also usable.

At the time, the intermediate transfer belt 61 is brought into contact with the transfer roller 10 by giving a predetermined nip, and voltage is applied to the transfer roller 10 in order to transfer a toner to a sheet (high voltage of polarity (+) opposite to charging polarity (−) of a toner). Further, for the purpose of steadily obtaining the above-described nip by the transfer roller 10, either one of the transfer roller 10 or the intermediate transfer belt driving roller 62 is made of a hard material (metal or the like), and the other is made of a soft material such as an elastic roller (an elastic rubber roller, a formable resin roller or the like).

Moreover, as described above, a toner which attaches to the intermediate transfer belt 61 by contact with the photoreceptor drum 3 or a toner which remains on the intermediate transfer belt 61 without being transferred onto recording paper by the transfer roller 10, because of causing generation of a mixed color of toners at next step, is set to be removed/collected by the intermediate transfer belt cleaning unit 65. The intermediate transfer belt cleaning unit 65 is provided with, for example, a cleaning blade as a cleaning member in contact with the intermediate transfer belt 61, and the intermediate transfer belt 61 in contact with the cleaning blade is supported by the intermediate transfer belt driven roller 63 on the back side thereof.

The paper feeding cassette 81 is a tray for accumulating recording paper (sheets) to be used for image formation, and provided on a lower side of the exposure unit 1 of the apparatus 130. Additionally, the recording paper to be used for image formation is able to be placed also in a manual paper feeding cassette 82. Further, the paper discharge tray 91 provided above the apparatus 130 is a tray for piling up the printed recording paper facedown.

Further, the apparatus 130 is provided with a paper conveyance path S1 in an approximately vertical shape for feeding recording paper in the paper feeding cassette 81 and the manual paper feeding cassette 82 to the paper discharge tray 91 through the transfer roller 10 and the fixing unit 7. Near the paper conveyance path S1 from the paper feeding cassette 81 or the manual paper feeding cassette 82 to the paper discharge tray 91, pick-up rollers 11a and 11b, a plurality of conveying rollers 12a to 12d, a registration roller 13, the transfer roller 10, the fixing unit 7 and the like are arranged.

The conveying rollers 12a to 12d are small-size rollers for promoting and assisting conveyance of recording paper, a plurality of which are arranged along the paper conveyance path S1. Further, the pick-up roller 11a is provided near the end of the paper feeding cassette 81, and picks recording paper up from the paper feeding cassette 81 sheet by sheet for supplying to the paper conveyance path S1. Similarly, the pick-up roller lib is provided near the end of the manual paper feeding cassette 82, and picks recording paper up from the manual paper feeding cassette 82 sheet by sheet for supplying to the paper conveyance path S1.

Furthermore, the registration roller 13 keeps once the recording paper conveyed through the paper conveyance path S1. And, provided is a function for conveying the recording paper to the transfer roller 10 at the time of lining up a leading end of a toner image on the photoreceptor drum 3 with a leading end of the recording paper.

The fixing unit 7 is provided with a heat roller 71 and a pressurizing roller 72. The heat roller 71 and the pressurizing roller 72 rotate by holding recording paper therebetween. Additionally, the heat roller 71 is set so as to be at predetermined fixing temperature by control means based on a signal from a not-shown temperature detector, and has a function for bringing with the pressurizing roller 72 a toner into thermocompression bonding to recording paper, thereby applying fusing, mixing and pressure-contact to a multicolor toner image that is transferred to the recording paper for bringing the recording paper into heat fixing. Further, an outer heating belt 73 is provided for heating the heat roller 71 from outside.

Next, description will be given more specifically for a sheet conveyance path of recording paper. As described above, the image forming apparatus 100 is provided in advance with the paper feeding cassette 81 and the manual paper feeding cassette 82 for containing recording paper. In order to feed recording paper from these paper feeding cassettes 81 and 82, for which, the pick-up rollers 11a and 11b are respectively arranged to guide the recording paper to the paper conveyance path S1 sheet by sheet.

The recording paper that is conveyed from each of the paper feeding cassettes 81 and 82 is conveyed to the registration roller 13 by the conveying roller 12a of the paper conveyance path S1, then conveyed to the transfer roller 10 at the time of matching a leading end of the recording paper to a leading end of image information on the intermediate transfer belt 61, in which the image information is written onto the recording paper. Thereafter, the recording paper passes through the fixing unit 7, whereby an unfixed toner on the recording paper is fused and fixed by heat, then discharged onto the paper discharge tray 91 through the arranged conveying roller 12b.

The above-described conveyance path is shown at the time of requesting single-sided printing for recording paper, and on the other hand, at the time of requesting double-sided printing, when a rear end of the recording paper which passes through the fixing unit 7 after completing single-sided printing as described above is held by the last conveying roller 12b, the recording paper is guided to a conveyance path S2 in which the conveying rollers 12c and 12d are arranged by a reverse rotation of the conveying roller 12b. Then, the conveyance path S2 joins the conveyance path S1, and the recording paper is conveyed from the registration roller 13 to the transfer roller 10. At the time, a front/back side of the recording paper is reversed at a stage of joining from the conveyance path S2 to the conveyance path S1, and printing is thus performed on the back side of the recording paper at the transfer roller 10. Then, the recording paper on which the back side is printed is fixed by the fixing unit 7 to be discharged to the paper discharge tray 91.

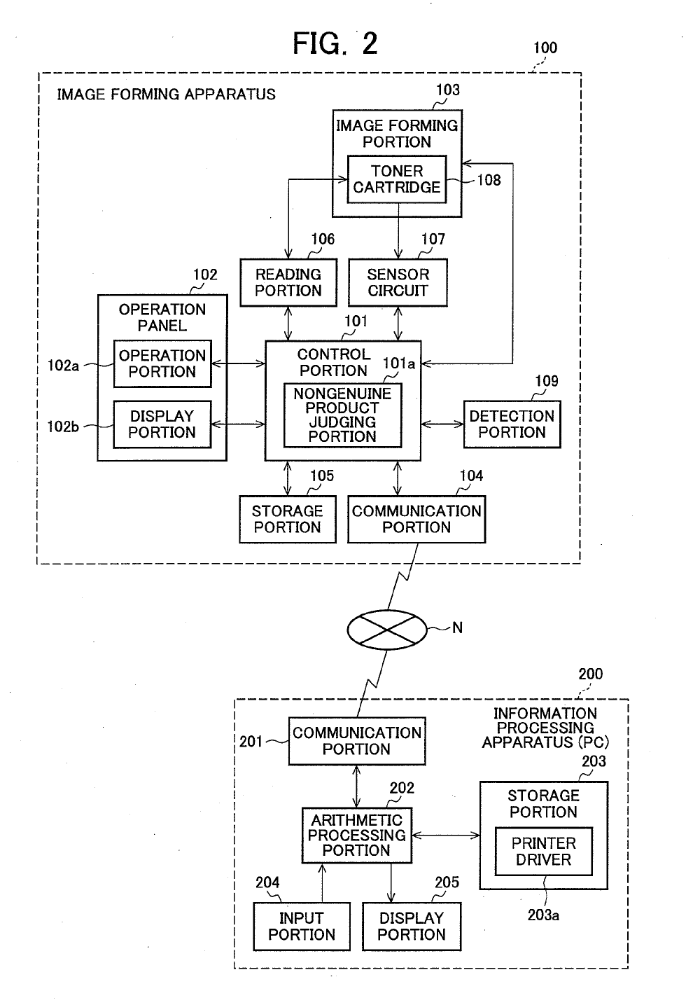

FIG. 2 is a block diagram showing an exemplary main configuration of the image forming apparatus according to the present invention and an information processing apparatus. The image forming apparatus 100 is configured as, for example, the above-described multi-functional peripheral, comprised of a control portion 101 for controlling each function of the image forming apparatus 100 to be realized by a microcomputer having a CPU, a ROM, a RAM and the like inside thereof; an operation panel 102 composed of an operation portion 102a and a display portion 102b; an image forming portion 103 for performing image formation of image data on recording paper according to control of the control portion 101; a communication portion 104 for connecting to an information processing apparatus 200 via a network N; a storage portion 105 such as a hard disk; a reading portion 106 for reading ID information from an IC chip imparted to a toner cartridge 108; a sensor circuit 107 composed of a peripheral circuit for processing various sensors and signals from the sensors; the toner cartridge 108 as an example of a replacement part; and a detection portion 109 for detecting temperature and/or humidity.

The operation panel 102 is composed of the operation portion 102a and the display portion 102b, and the operation portion 102a receives operation input by a user for outputting to the control portion 101. Further, the display portion 102b displays a screen for operation and various types of information. A touch panel on which input operation is enabled with respect to an operation screen by the operation portion 102a and the display portion 102b is configured.

Moreover, the information processing apparatus 200 is, for example, a general purpose PC (personal computer) comprised of a communication portion 201 for connecting to the image forming apparatus 100 via the network N; an arithmetic processing portion 202 composed of a CPU, a RAM, a ROM and the like for controlling each function of the information processing apparatus 200; a storage portion 203 such as a hard disk in which a printer driver 203a is installed; an input portion 204 such as a keyboard and a mouse; and a display portion 205 such as a liquid crystal display. The printer driver 203a is software (program) which controls the image forming apparatus 100 for executing image forming processing (print processing). This printer driver 203a is read from the storage portion 203 by the arithmetic processing portion 202 in execution of printing to be developed and executed on the RAM of the arithmetic processing portion 202.

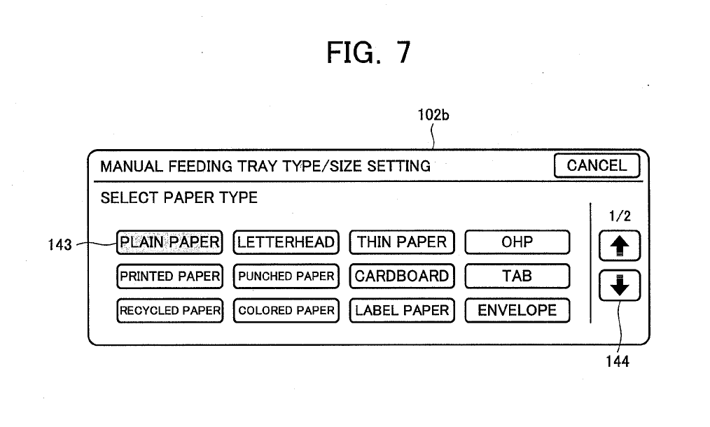

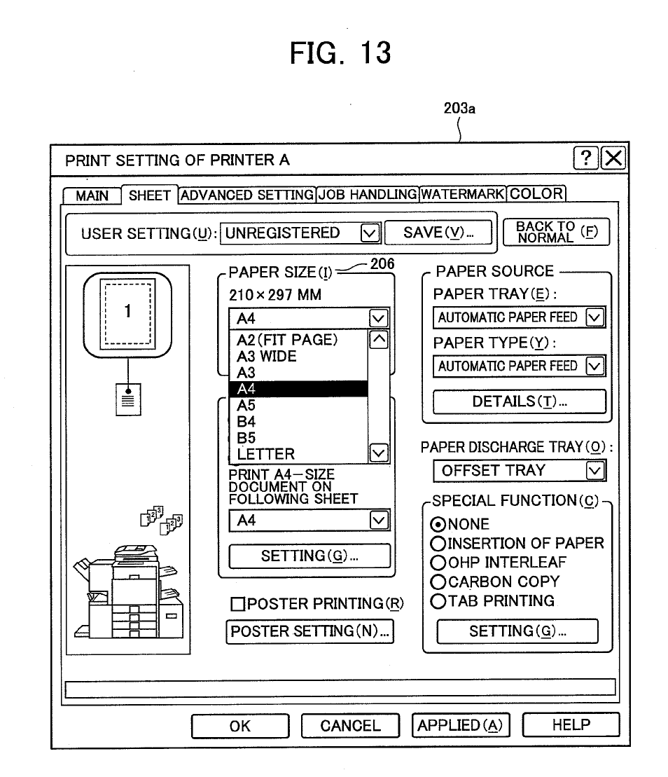

A main object of the present invention is to suppress waste of recording paper due to unevenness, fog and the like of an image without impairing user's convenience even in the case of using a nongenuine product for a replacement part. As a configuration therefore, the image forming apparatus 100 is provided with a nongenuine product judging portion 101a for judging whether or not a replacement part of the image forming portion 103 is a nongenuine product, and the control portion 101 for controlling the image forming portion 103 according to an image forming condition input from the an image forming condition input portion, in which, in a case where the replacement part of the image forming portion 103 is judged as a nongenuine product by the nongenuine product judging portion 101a, the control portion 101 restricts input of a condition concerning recording paper among the image forming conditions capable of being input from the image forming condition input portion. Note that, the nongenuine product judging portion 101a is realized as one function of the control portion 101. Further, the image forming condition input portion is provided with a copy condition input screen (FIG. 7 to FIG. 10 described below, also referred to as a copy condition setting screen) which is displayed on the operation panel 102 (display portion 102b) of the image forming apparatus 100, or a print condition input screen (FIG. 13 to FIG. 16 described below, also referred to as a print condition setting screen) of the printer driver 203a that is displayed on the display portion 205 of the information processing apparatus 200.

In the above description, the replacement part configures a part of an apparatus in light of a function, whose performance is able to be recovered and retained by replacement. For example, a toner cartridge (or development cartridge), a photoreceptor cartridge, a cartridge in which a development member and a photoreceptor are integrally formed, an ink cartridge, a cartridge in which an ink tank and a print head are integrally formed, an ink sheet cartridge for a thermal transcription formula, and the like are applicable for the image forming apparatus 100. Then, these replacement parts are referred to as supplies in some cases. In description of the present embodiment, the toner cartridge 108 will be illustrated and explained as a replacement part, which is however not limited thereto.

In FIG. 2, the nongenuine product judging portion 101a judges whether the toner cartridge 108 mounted on the image forming apparatus 100 is a genuine product or a nongenuine product. A judging method of the nongenuine product is able to be realized by means of conventional public known techniques of, for example, Japanese Laid-Open Patent Publication No. 2002-202697, Japanese Laid-Open Patent Publication No. 2009-145396 and the like in addition to techniques described in the above-described Japanese Laid-Open Patent Publication No. 2010-266588 and Japanese Laid-Open Patent Publication No. 2009-300694, which method is not particularly limited. Hereinafter, description will be given as an illustration for a case where judgment is made in the image forming apparatus 100 as a judging method of a nongenuine product by the nongenuine product judging portion 101a, however, an external server device or the like may be used for judgment.

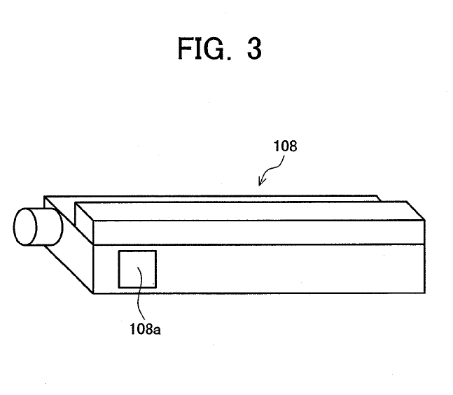

In the toner cartridge 108, specific ID information capable of individually specifying the toner cartridge 108 is recorded. For example, as shown in FIG. 3, the ID information is installed as an IC chip 108a to be recorded in advance in a non-volatile memory such an EEPROM and a ferroelectric memory inside thereof. Alternatively, such ID information may be configured by a simple method such as a bar code. The ID information may be an identification number or the like of a manufacturer because of only needing to recognize at least a manufacturer supplying a genuine product. Then, the reading portion 106 differs depending on a form of the ID information imparted to the toner cartridge 108, comprised of a bar code reader in the case of the bar code, or electric or high-frequency reading means in the case of an IC chip.

Additionally, in the storage portion 105, ID information of a genuine product of a toner cartridge is stored in advance, and in the case of confirming the toner cartridge 108 is replaced and mounted, the nongenuine product judging portion 101a compares ID information of the toner cartridge 108 read by the reading portion 106 to ID information of a genuine product stored in the storage portion 105 to judge whether or not the both of them are consistent with each other. Note that, a manufacturer of the image forming apparatus 100 may store all of ID information of a genuine toner cartridge in the storage portion 105 at a manufacturing process thereof. In a case where the ID information is consistent with each other, judgment is made as a genuine product, and in a case where ID information is not consistent with each other, judgment is made as a nongenuine product. Note that, some nongenuine products are considered as being in a case where ID information is not imparted, thus allowing to judge as a nongenuine product even in the case of being incapable of reading at the reading portion 106.

In the above description, replacement and mounting of the toner cartridge 108 are detectable by the sensor circuit 107. The sensor circuit 107 is, as described above, composed of a peripheral circuit for processing various sensors and signals from the sensors. A sensor is composed of a mechanical or optical door sensor and a cartridge sensor. The door sensor is a sensor for detecting an opening/closing state of a door of the image forming apparatus 100, and the cartridge sensor is a sensor for detecting whether or not the toner cartridge 108 is mounted on the image forming apparatus 100. The peripheral circuit includes a waveform shaping circuit for performing waveform shaping of sensor output, a filter circuit, a binarized circuit, a voltage level control circuit, and the like, in which the sensor output is converted to, for example, a digital signal having a logic level of 0 to 5 V.

The control portion 101 accesses the IC chip 108a when detecting that the toner cartridge 108 is replaced in the sensor circuit 107, and instructs the reading portion 106 to read ID information. Then, the nongenuine product judging portion 101a compares ID information read by the reading portion 106 to ID information stored in the storage portion 105, thereby judging whether the replaced toner cartridge 108 is a genuine product or a nongenuine product. In this manner, the nongenuine product judging portion 101a is able to judge whether the ID information is consistent/inconsistent with each other. Even in the case of being incapable of reading by the reading portion 106, judgment is made as inconsistency, that is, a nongenuine product.

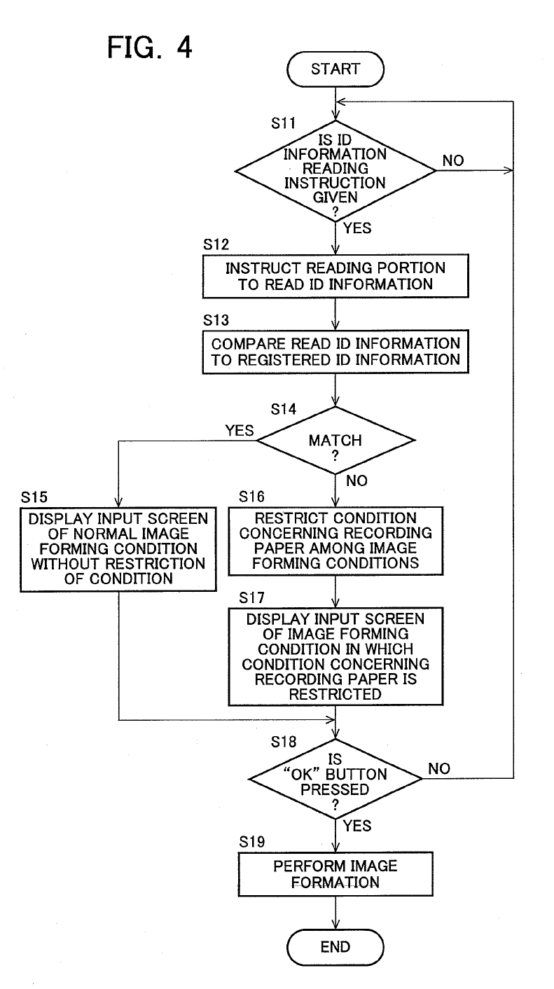

FIG. 4 is a flow diagram for explaining an example of an image forming method by means of the image forming apparatus of the present invention. In this example, description will be given for a case where an ID information reading instruction is given when the sensor circuit 107 detects the toner cartridge 108 is mounted based on the configuration of the image forming apparatus 100 of FIG. 2. First, the control portion 101 judges whether or not the ID information reading instruction is given from the sensor circuit 107 along with mounting of the toner cartridge 108 (step S11), and in the case of judging that the ID information reading instruction is given (in the case of YES), instructs the reading portion 106 to read ID information of the toner cartridge 108 (step S12). Moreover, at step S11, in the case of judging that the ID information reading instruction is not given (in the case of NO), the process moves to a standby state at step S11.

Next, the control portion 101 (nongenuine product judging portion 101a) compares ID information read by the reading portion 106 to ID information stored in the storage portion 105 (registered ID information) (step S13). Then, judgment is made whether or not both of them are consistent with each other (step S14), and in the case of being consistent with each other (in the case of YES), the toner cartridge 108 is determined as a genuine product, then the image forming apparatus 100 or the information processing apparatus 200 displays an input screen for a normal image forming condition without restriction for conditions according to predetermined operation (copy operation or print operation) by a user (step S15), followed by movement to step S18. Then, judgment is made whether or not an “OK” button is pressed on the input screen for the normal image forming condition (step S18), and in the case of judging that the “OK” button is pressed (in the case of YES), the image forming portion 103 performs image formation based on the image forming condition input at step S15 according predetermined operation (for example, pressing of a copy start button, a print start button or the like) by the user (step S19). Additionally, at step S14, in the case of being not consistent with each other or incapable of reading at the reading portion 106 (in the case of NO), the toner cartridge 108 is judged as a nongenuine product, and the control portion 101 restricts a condition concerning recording paper among image forming conditions capable of being input from the copy condition input screen of the image forming apparatus 100 or the print condition input screen by the printer driver 203a of the information processing apparatus 200 (step S16).

Note that, a judgment result at step S14 is sent from the image forming apparatus 100 to the information processing apparatus 200 as genuine part judgment information. Then, such genuine part judgment information is stored in the storage portion 203 of the information processing apparatus 200 to be referred in activation of the printer driver 203a and the like. This makes it possible to judge whether or not the toner cartridge 108 is a nongenuine product even on the information processing apparatus 200 side. Further, a judgment result at step S14 may also be stored in the storage portion 105 of the image forming apparatus 100 as the genuine part judgment information. In this case, when the printer driver 203a of the information processing apparatus 200 is activated, the information processing apparatus 200 reguests the image forming apparatus 100 to send the genuine part judgment information to obtain the genuine part judgment information from the image forming apparatus 100. Then, judgment is able to be made whether or not the toner cartridge 108 is a nongenuine product even on the information processing apparatus 200 side based on the genuine part judgment information obtained from the image forming apparatus 100. When the toner cartridge 108 is judged as a nongenuine product, the printer driver 203a generates the print condition input screen in which the condition concerning recording paper is restricted.

At step S16, the condition concerning recording paper is a kind of recording paper, in which the control portion 101 restricts so as not to be able to input special paper (a tab, a cardboard, thin paper, OHP paper and the like) among types of recording paper capable of being input from the copy condition input screen or the print condition input screen. Alternatively, when a size of recording paper which is a predetermined size (for example, B4 size) or more is input from the copy condition input screen or the print condition input screen, it may be restricted so as not to be able to input the special paper. Specifically, when the kind of the recording paper is displayed to be selectable on the copy condition input screen or the print condition input screen, it is possible to control so as to hide the special paper on the screen, or control so as to display the special paper in gray-out on the screen. Note that, the print condition input screen is generated by the printer driver 203a, and the printer driver 203a is configured to generate the print condition input screen corresponding to genuine product judgment information (judgment result) that is sent from the image forming apparatus 100.

Further, the condition concerning the recording paper may be a size of recording paper. In this case, the control portion 101 restricts so as not to be able to input a predetermined size (for example, B4 size) or more among sizes of recording paper capable of being input from the copy condition input screen or the print condition input screen. Alternatively, when the special paper as the kind of the recording paper is input from the copy condition input screen or the print condition input screen, it may be restricted so as not to be able to input the paper size of the predetermined size or more. Specifically, when the size of the recording paper is displayed to be selectable on the copy condition input screen or the print condition input screen, it is possible to control so as to hide the paper size of the predetermined size or more on the screen, or control so as to display the paper size of the predetermined size or more in gray-out on the screen. Note that, whether to restrict both of the kind and the size of the recording paper or to restrict only either of them may be appropriately performed by setting by a user.

Next, the image forming apparatus 100 or the information processing apparatus 200 displays, according to predetermined operation by a user, the image forming condition input screen in which the condition concerning the recording paper is restricted at step S16, that is, the copy condition input screen on the display portion 102b of the image forming apparatus 100 in the case of copy operation, and displays the print condition input screen of the printer driver 203a on the display portion 205 of the information processing apparatus 200 in the case of print operation (step S17). Note that, the image forming condition input screen means the copy condition input screen shown in FIG. 7 to FIG. 10, or the print condition input screen shown in FIG. 13 to FIG. 16, which are described below.

At the above-described step S17, in the case of restricting the condition concerning the recording paper, a reason thereof is preferably informed for understanding of a user by displaying on the image forming condition input screen a message or the like that the toner cartridge 108 is a nongenuine product and thus restricted. Then, on the image forming condition input screen, judgment is made whether or not an “OK” button is pressed (step S18), and in the case of judging that the “OK” button is pressed (in the case of YES), the image forming portion 103 performs image formation based on the image forming condition input at step S17 according to predetermined operation (for example, pressing of the copy start button or the print start button, or the like) by the user (step S19). Additionally, at step S18, in the case of judging that the “OK” button is not pressed and a “cancel” button is pressed (in the case of NO), the process returns to step S11 for repeating the process.

Note that, at step S18, in a case where a desired image forming condition is not displayed on the image forming condition input screen at step S17, a user is able to press a “cancel” button. In this case, it is believed that information at step S17 allows the user to recognize that it is impossible to print with the desired image forming condition since the toner cartridge 108 is a nongenuine product, thus performing action such as replacement of the nongenuine toner cartridge 108 with a genuine product again. Then, in the case of replacing with a genuine toner cartridge, a flow of FIG. 4 is executed again, which makes it possible to perform image formation with the desired image forming condition.

Here, in FIG. 2, the image forming apparatus 100 is provided with, for example, the detection portion 109 for detecting temperature and/or humidity under an environment where the image forming apparatus 100 is installed. Then, when the toner cartridge 108 is judged as a nongenuine product while the temperature and/or the humidity detected by the detection portion 109 do not fall within a predetermined range, the control portion 101 may prohibit all input of image forming conditions capable of being input from the image forming condition input screen so as not to allow execution of image forming processing. When the toner cartridge 108 is a nongenuine product, it is hard to perform favorable image forming processing under an environment at high temperature and high humidity, or low temperature and low humidity exceeding the predetermined range. Accordingly, all input of the image forming conditions is prohibited so that wasteful image forming processing is prevented from being executed. Also in this case, it is preferable to notify the user of a reason why the image forming processing is not able to be executed so as to prompt replacement with a genuine product of the toner cartridge.

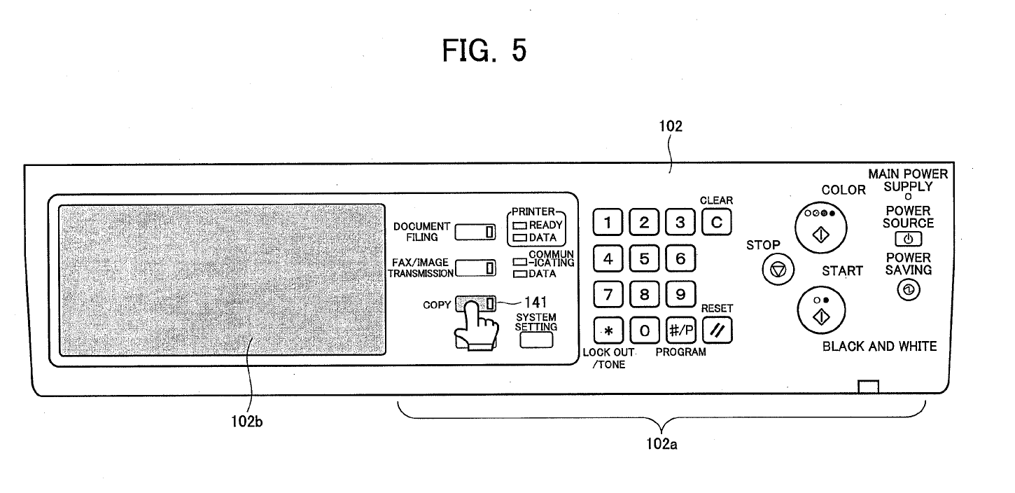

Hereinafter, description will be given for an example of image transition of the operation panel 102 (display portion 102b) in copy processing of the image forming apparatus 100. FIG. 5 is a diagram showing an example of appearance of the operation panel 102 included in the image forming apparatus 100. The operation panel 102 is, as described above, comprised of the operation portion 102a and the display portion 102b, in which the display portion 102b is composed of a touch panel. In the case of image forming apparatus 100, the image forming condition input portion is comprised of a copy condition input screen that is displayed on the display portion 102b and the touch panel. The display portion 102b is able to receive input by touch operation of a user via the touch panel.

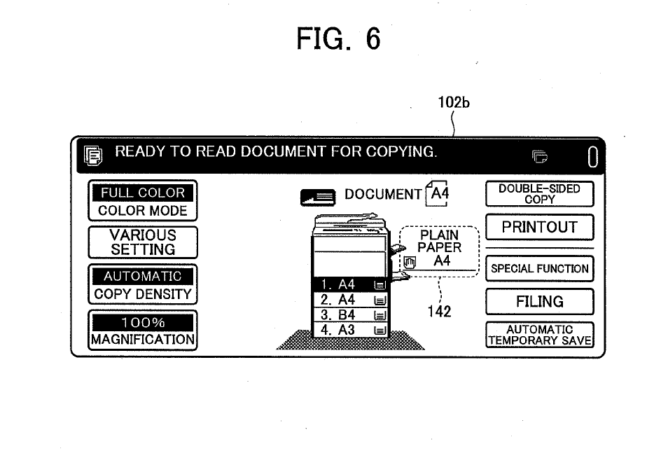

In the case of copying, when a user presses a copy mode selection button 141 of the operation portion 102a, an initial screen in a copy mode is displayed on the display portion 102b as shown in FIG. 6. On the initial screen of FIG. 6, a layout image showing a contour of the apparatus is displayed on the center of the screen, and each size of recording paper set to paper feeding cassettes 1 to 4 and a manual feeding tray is displayed. In such a screen example of FIG. 6, the paper feeding cassette 1 in which A4 paper is contained is selected by default. Note that, when the toner cartridge 108 is a nongenuine product, for example, since it is restricted so as not to be able to input a paper size of a B4 size or more, the paper feeding cassette 3 in which B4 paper is contained and the paper feeding cassette 4 in which A3 paper is contained will not be selected by default.

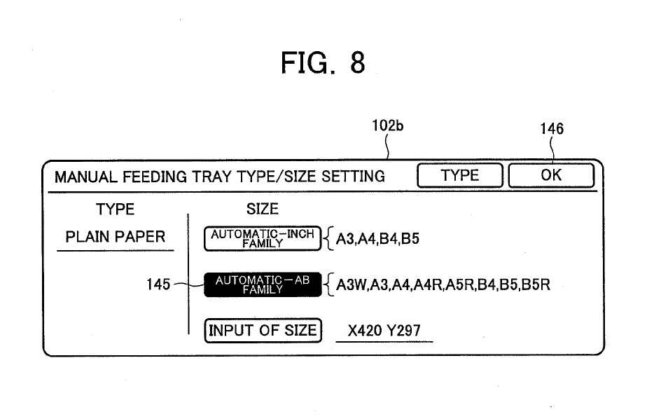

Then, when a user touches, for example, a “plain paper A4” 142 showing the manual feeding tray from a screen of FIG. 6, a screen for selecting a paper type (a kind of paper) to be set to the manual feeding tray is displayed (FIG. 7), and additionally, a screen for selecting a paper size is displayed (FIG. 8). Note that, in the case of this example, it is assumed that “plain paper/A4” is set to the manual feeding tray by default. FIGS. 7 and 8 are screen examples in a case where the toner cartridge 108 is a genuine product, and selection of the paper type and the paper size is not limited. In FIG. 7, when the user selects, for example, “plain paper” 143 as the paper type to touch a “downward arrow” button 144, the process moves to a screen of FIG. 8 to allow the paper size to be selected. Here, an “automatic—AB system” 145 is selected, and when the user further touches an “OK” button 146, the paper type and the paper size for the manual feeding tray are set. In this example, “plain paper” and “automatic—AB system” are set.

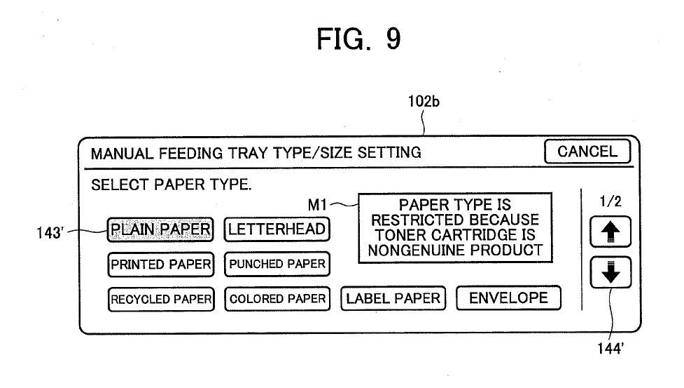

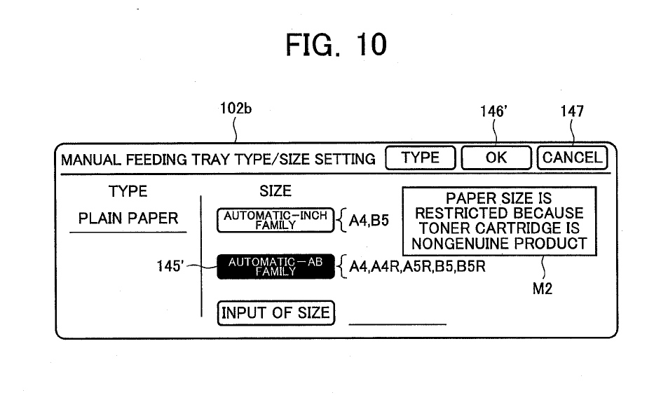

Next, an example of the copy condition input screen according to the present invention is shown in FIG. 9 and FIG. 10. When a user touches “plain paper A4” 142 indicating the manual feeding tray from the above-described initial screen of FIG. 6, a screen for selecting the paper type to be set to the manual feeding tray is displayed (FIG. 9), and additionally, a screen for selecting the paper size is displayed (FIG. 10). FIGS. 9 and 10 show an example of the copy condition input screen, which is a screen display example in a case where the toner cartridge 108 is a nongenuine product.

In a screen example of FIG. 9, special paper (thin paper, a cardboard, OHP paper and a tab) is hidden among the paper types displayed in FIG. 7 so as not to be able to be selected. Note that, such special paper may be displayed in gray-out so as not to be selectable. That is, the control portion 101 controls, in the case of displaying the paper type on the copy condition input screen so as to be selectable, so that the special paper is hidden or displayed in gray-out on the screen. In the screen example of FIG. 9, in order to notify a user of a reason why the special paper is not selectable, for example, a message M1 is displayed that “Paper type is restricted because toner cartridge is nongenuine product.”

In FIG. 9, when a user selects, for example, “plain paper” 143′ as the paper type to touch a “downward arrow” button 144′, the process moves to a screen of FIG. 10. In a screen example of FIG. 10, the paper size of a B4 size or more is hidden among the paper sizes displayed in FIG. 8 so as not to be selectable. Note that, as with the above, the paper size of the B4 size or more may be displayed in gray-out so as not to be selectable. That is, the control portion 101 controls, in the case of displaying the paper size on the copy condition input screen so as to be selectable, so that the paper size of the B4 size or more is hidden or displayed in gray-out on the screen. In the screen example of FIG. 10, in order to notify a user of a reason why the paper size of the B4 size or more is not selectable, for example, a message M2 is displayed that “Paper size is restricted because toner cartridge is nongenuine product.”

Here, the control portion 101 may restrict, when the special paper is input from the copy condition input screen as a kind of recording paper, so as not to be able to input the B4 size or more among the sizes of the recording paper capable of being input. In this case, even when the toner cartridge 108 is a nongenuine product, the screen of FIG. 7 is displayed, and the special paper is able to be input as the kind of the recording paper. However, when the special paper is selected and input, the B4 size or more is not able to be input as the paper size, thus restricting the paper size to be allowed for copy to A4, A4R, A5R, B5 and B5R as shown in FIG. 10. In this example, it is assumed that a screen is displayed in order of FIG. 7 and FIG. 10.

Further, conversely, the control portion 101 may restrict, when the size of the recording paper in the B4 size or more is input from the copy condition input screen, so that the special paper is not able to be input among the kinds of the recording paper capable of being input. In this case, even when the toner cartridge 108 is a nongenuine product, the screen of FIG. 8 is displayed, and the paper size of the B4 size or more is able to be input. However, when the paper size of the B4 size or more is selected and input, since the special paper is not able to be input as the paper type, the paper type to be allowed for copy is restricted to other than the special paper as shown in FIG. 9. In this example, it is assumed that a screen is displayed in order of FIG. 8 and FIG. 9.

In the screen example of FIG. 10, “automatic-AB system” 145′ is selected, and when a user further touches an “OK” button 146′, the paper type and the paper size are set for the manual feeding tray. In this example, “plain paper” and “automatic-AB system” are set, however, the paper size to be allowed for copy is restricted to A4, A4R, A5R, B5 and B5R. Then, when the recording paper is set to the manual feeding tray after the paper type and the paper size are set to the manual feeding tray, presence/absence of the recording paper with a sensor such as a paper detecting guide for the manual feeding tray as well as a closest recording paper size from the above-described paper sizes with a guide board are detected.

Note that, in a state where the screen of FIG. 10 is displayed, in a case where a user desires to copy to, for example, a sheet in the B4 size or more, when a “cancel” button 147 of FIG. 10 is touched, the process transits to the initial screen of FIG. 6. Then, when the user replaces the nongenuine toner cartridge 108 with a genuine product, the above-described flow explained in FIG. 4 is executed again, and restriction of the paper size is cancelled, thus making it possible to select the sheet in the B4 size or more.

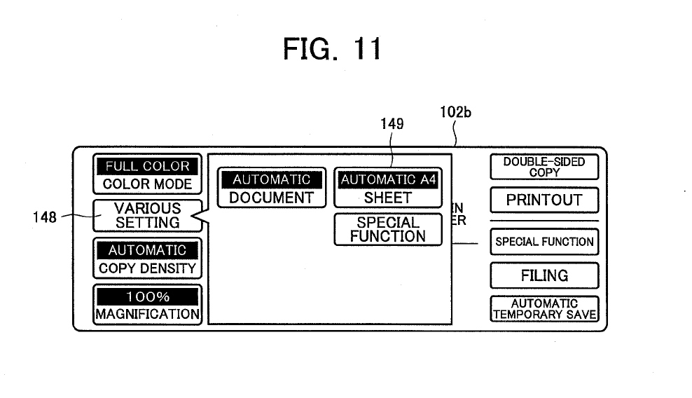

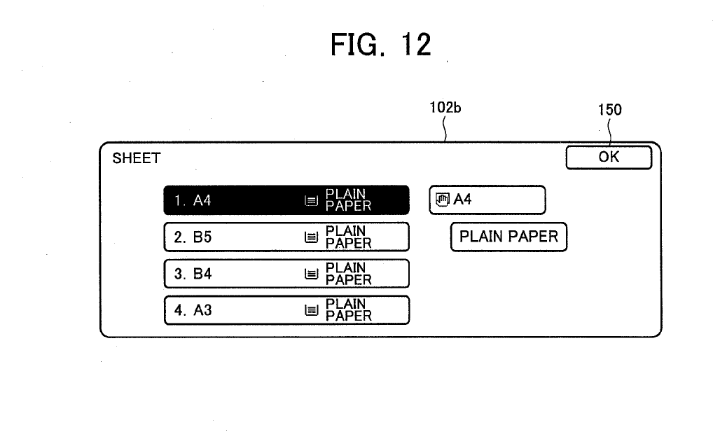

Moreover, a setting method of the paper types and the paper sizes for the paper feeding cassettes 1 to 4 is also basically the same as the case of the manual feeding tray, however, in the case of the paper feeding cassettes 1 to 4, a user presses a “various setting” button on the above-described initial screen of FIG. 6. A screen example including a “various setting” button 148 at the time is shown in FIG. 11. Then, when the user touches a “sheet” button 149 of FIG. 11, the process moves to a screen example of FIG. 12 so that it is possible to set from a screen of FIG. 12 the paper type and the paper size for each paper feeding cassette. On the screen of FIG. 12, the paper feeding cassette 1 is selected by default, and the paper feeding cassette 1 is set to “A4, plain paper”. In FIG. 12, when the toner cartridge 108 is a nongenuine product, for example, it is restricted so as not to allow the paper size of the B4 size or more to be input, and the paper feeding cassette 3 in which B4 paper is contained and the paper feeding cassette 4 in which A3 paper is contained are thus hidden or displayed in gray-out, so that the user is not able to select these B4 paper and A3 paper.

Then, when the toner cartridge 108 is a nongenuine product, when the user touches an “OK” button 150 in a state where the paper feeding cassette 1 is selected on the screen of FIG. 12 (state of being highlighted), as with the above-described case of the manual feeding tray, a screen for selecting a paper type (kind of paper) to be set to the paper feeding cassette 1 is displayed (FIG. 9), and additionally, a screen for selecting a paper size is displayed (FIG. 10).

Next, description will be given for a print processing example with an image forming system comprised of the image forming apparatus 100 and the information processing apparatus 200. In the above-described FIG. 2, the image forming apparatus 100 is provided with the communication portion 104 for sending a judgment result by the nongenuine product judging portion 101a to the information processing apparatus 200. The printer driver 203a of the information processing apparatus 200 restricts, in a case where a judgment result from the image forming apparatus 100 is a nongenuine product, input of a condition concerning recording paper among image forming conditions capable of being input from the print condition input screen of the printer driver 203a. In the case of information processing apparatus 200, the image forming condition input portion is comprised of a print condition input screen that is displayed on the display portion 205 by the printer driver 203a and the input portion 204 for receiving input operation from a user.

In the above description, the judgment result by the nongenuine product judging portion 101a is sent as genuine part judgment information from the image forming apparatus 100 to the information processing apparatus 200. Then, such genuine part judgment information is stored in the storage portion 203 of the information processing apparatus 200 to be referred in activation of the printer driver 203a and the like. This makes it possible to judge whether or not the toner cartridge 108 is a nongenuine product even on the information processing apparatus 200 side. Further, a judgment result by the nongenuine product judging portion 101a may also be stored in the storage portion 105 of the image forming apparatus 100 as the genuine part judgment information. In this case, when the printer driver 203a is activated in the information processing apparatus 200, the information processing apparatus 200 requests the image forming apparatus 100 to send the genuine part judgment information to obtain the genuine part judgment information from the image forming apparatus 100. Then, judgment is able to be made even on the information processing apparatus 200 side whether or not the toner cartridge 108 is a nongenuine product based on the genuine part judgment information obtained from the image forming apparatus 100.

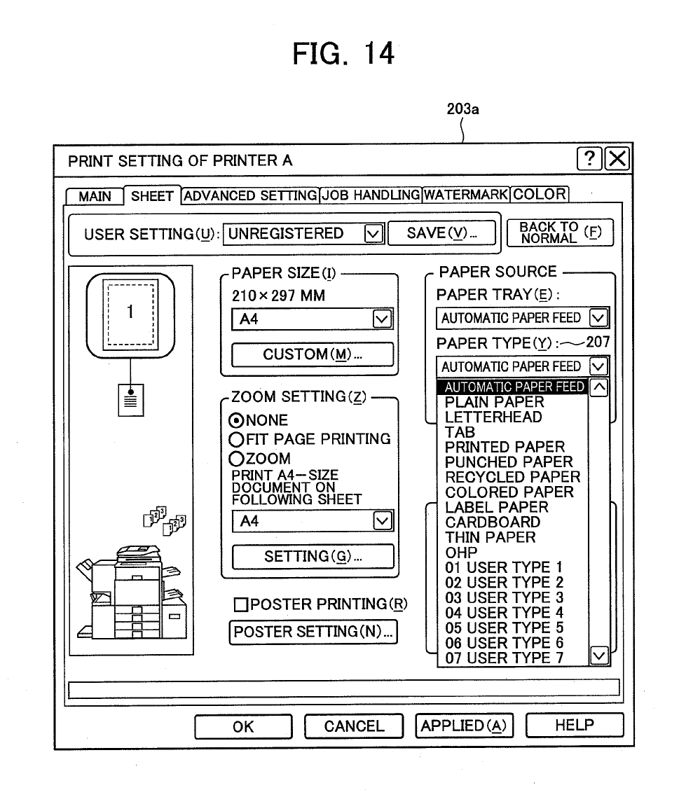

Hereinafter, description will be given for a screen example of the printer driver 203a of the information processing apparatus 200 in print processing of the image forming apparatus 100. FIGS. 13 and 14 are diagrams showing an example of a print condition input screen that is displayed by the printer driver 203a of the information processing apparatus 200. Screen examples of FIGS. 13 and 14 show screen display examples in a case where the toner cartridge 108 is a genuine product. In FIG. 13, when a user selects a paper size 206, all paper sizes that are allowed for printing in the image forming apparatus 100 are displayed. Further, in FIG. 14, when the user selects a paper type 207, all paper types that are allowed for printing in the image forming apparatus 100 are displayed.

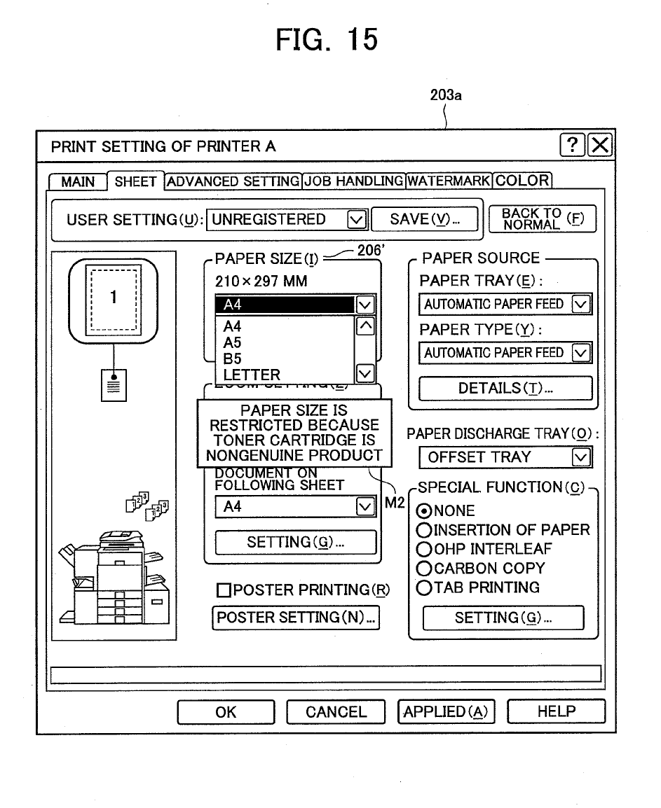

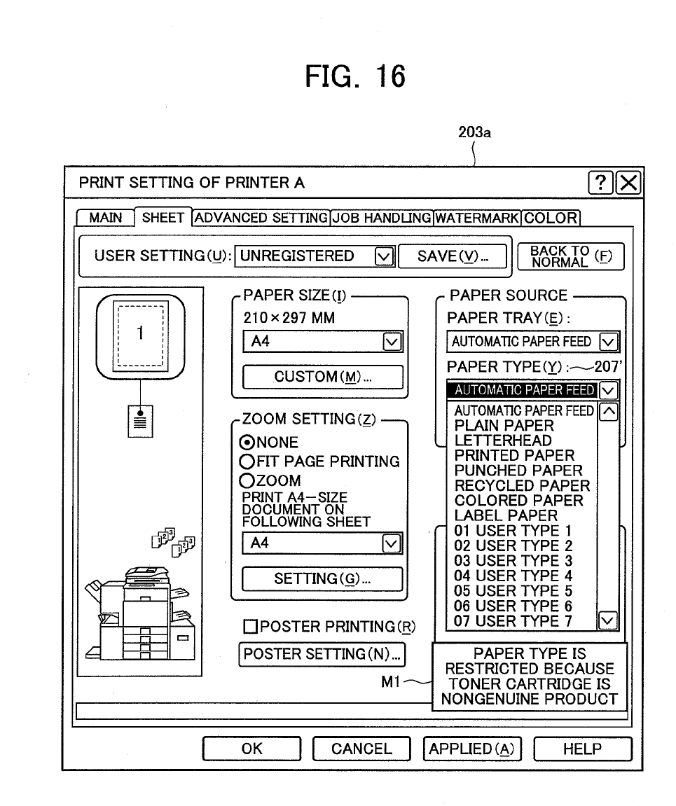

Next, an example of the print condition input screen by the printer driver 203a according to the present invention is shown in FIG. 15 and FIG. 16. Screen examples of FIGS. 15 and 16 show screen display examples in a case where the toner cartridge 108 is a nongenuine product. In FIG. 15, when a user selects a paper size 206′, the paper size to be allowed for printing is displayed in a state of being restricted to A5, A4, B5 and a letter. That is, a sheet in the B4 size or more is hidden so as not to be selectable. Also in this case, the sheet in the B4 size or more may be displayed in gray-out so as not to be selectable. In the screen example of FIG. 15, in order to notify a user of a reason why the sheet in the B4 size or more is not selectable, for example, a message M2 is displayed that “Paper size is restricted because toner cartridge is nongenuine product.”

Further, in FIG. 16, when a user selects a paper type 207′, the paper type to be allowed for printing is displayed in a state of being restricted to other than special paper (thin paper, a cardboard, OHP paper and a tab). That is, the special paper is hidden so as not to be selectable. Also in this case, the special paper may be displayed in gray-out so as not to be selectable. In the screen example of FIG. 16, in order to notify a user of a reason why the special paper is not selectable, for example, a message M1 is displayed that “Paper type is restricted because toner cartridge is nongenuine product.”

Here, the B4 size or more may be restricted, when the special paper is input from the print condition input screen as a kind of recording paper, so as not to be capable of being input among the sizes of the recording paper capable of being input. In this case, even when the toner cartridge 108 is a nongenuine product, the screen of FIG. 14 is displayed, and the special paper (thin paper, a cardboard, OHP paper and a tab) is able to be input as the kind of the recording paper. However, when the special paper is selected and input, the B4 size or more is not able to be input as the paper size, and the paper type to be allowed for printing is thus restricted to A4, A5, B5 and a letter as shown in FIG. 15. In this example, it is assumed that a screen is displayed in order of FIG. 14 and FIG. 15.

Further, conversely, the special paper may be restricted, when the size of the recording paper of the B4 size or more is input from the print condition input screen, so as not to be capable of being input among the kinds of the recording paper capable of being input. In this case, even when the toner cartridge 108 is a nongenuine product, the screen of FIG. 13 is displayed, and the paper size of the B4 size or more is able to be input. However, when the paper size other than A5, A4, B5 and a letter is selected and input, since the special paper is not able to be input as the paper type, the paper type to be allowed for printing is restricted to other than a tab, a cardboard, thin paper and OHP paper as the special paper as shown in FIG. 16, and such special paper is not selectable. In this example, it is assumed that a screen is displayed in order of FIG. 13 and FIG. 16.

When the special paper is set on the print condition input screen of the printer driver 203a or the copy condition input screen of the operation panel 102, bias that is applied to a photoreceptor drum, a transfer belt, a developing roller and the like constituting an image forming portion is generally set to prevent a development defect and a transfer defect, and additionally, fixing temperature of a fixing device is changed to prevent a fixing defect, an occurrence of wrinkles of thin paper and the like. However, in the case of using a nongenuine product for a replacement part of the image forming portion, it is impossible to assure whether an optimal image is obtained at the same bias setting as that of a genuine product. Whereas, in the present invention, in the case of using a nongenuine product, printing to special paper is prohibited so that it is possible to prevent wasteful use of recording paper.

Hereinabove, according to the present invention, when judgment is made that a nongenuine product other than a genuine product supplied by a manufacturer is used inside an apparatus, input of a condition concerning recording paper (a kind of paper, a paper size, and the like) is restricted among image forming conditions capable of being input, so that it is possible to permit printing in the case of recording paper with low occurrence frequency of a print defect, while prohibiting printing in the case of recording paper with high occurrence frequency of the print defect, thus making it possible to suppress waste of recording paper due to unevenness, fog and the like of an image without impairing user's convenience.

1. An image forming apparatus comprising:
an image forming portion for forming an image;
a nongenuine product judging portion for judging whether or not a replacement part of the image forming portion is a nongenuine product; and
a control portion for controlling the image forming portion according to an image forming condition input from an image forming condition input portion, wherein
in a case where the replacement part of the image forming portion is judged as a nongenuine product by the nongenuine product judging portion, the control portion restricts input of a condition concerning recording paper among image forming conditions that can be input from the image forming condition input portion.

2. The image forming apparatus as defined in claim 1, wherein
the condition concerning the recording paper is a kind of the recording paper, and the control portion restricts so as not to be able to input special paper among kinds of the recording paper that can be input from the image forming condition input portion.

3. The image forming apparatus as defined in claim 1, wherein,
the condition concerning the recording paper is a kind of the recording paper, and the control portion restricts so as not to be able to input special paper among kinds of the recording paper that can be input from the image forming condition input portion when a size of the recording paper of a predetermined size or more is input from the image forming condition input portion.

4. The image forming apparatus as defined in claim 1, wherein,
the condition concerning the recording paper is a size of the recording paper, and the control portion restricts so as not to be able to input the paper of a predetermined size or more among sizes of the recording paper capable of being input from the image forming condition input portion.

5. The image forming apparatus as defined in claim 1, wherein,
the control portion informs, in the case of restricting the condition concerning the recording paper, that the replacement part of the image forming portion is restricted because of being a nongenuine product.

6. The image forming apparatus as defined in claim 1, wherein,
a detection portion for detecting temperature and/or humidity is included, and when the replacement part of the image forming portion is judged as a nongenuine product and the temperature and/or the humidity detected by the detection portion do not fall within a predetermined range, the control portion prohibits all input of the image forming conditions that can be input from the image forming condition input portion so as not to allow execution of image forming processing.

7. The image forming apparatus as defined in claim 1, wherein,
the image forming apparatus is connected via a network to an information processing apparatus in which a printer driver is installed, and the image forming condition input portion includes a print condition input screen of the printer driver that is displayed on a display portion of the information processing apparatus.

8. An image forming method by means of an image forming apparatus provided with an image forming portion for forming an image; a nongenuine product judging portion for judging whether or not a replacement part of the image forming portion is a nongenuine product; and a control portion for controlling the image forming portion according to an image forming condition input from an image forming condition input portion, comprising:
a judging step that the nongenuine product judging portion judges whether or not the replacement part of the image forming portion is a nongenuine product;
an input restriction step that the control portion restricts input of a condition concerning recording paper among image forming conditions that can be input from the image forming condition input portion in a case where the replacement part is judged as a nongenuine product at the judging step; and
an image forming step that the image forming portion performs image formation based on an image forming condition in which the condition concerning the recording paper is restricted at the input restriction step.
